(19) United States
(12) Patent Application Publication
(10) Pub. No.: US 2016/0046027 A1
(43) Pub. Date: Feb. 18, 2016

(54) Hair Bang Clipper

(71) Applicant: Fringe Cosmetics, LLC, Palm Beach Gardens, FL (US)

(72) Inventor: Melissa Peverini, Palm Beach Gardens, FL (US)

(21) Appl. No.: 14/927,643

(22) Filed: Oct. 30, 2015

Related U.S. Application Data
(63) Continuation-in-part of application No. 14/268,600, filed on May 2, 2014.
Application No. 14/268,600 is a continuation-in-part of application No. 12/715,143, filed on Mar. 1, 2010, now abandoned.
(60) Provisional application No. 61/156,235, filed on Feb. 27, 2009.

(51) Int. Cl. B26B 13/24

(52) U.S. Cl. CPC B26B 13/24

(57) ABSTRACT

A hair clipper trimming device includes two arms that are pivotally connected. Each arm is constructed from a single piece of material with formed cutting edges. The arms are biased to an open position by a spring biasing member. The arms are constructed for ease of manufacturing and assembly. Assembly includes the use of restriction pins and slots to control the range of any pivot, and is coupled together by a press fit to eliminate the need for fasteners.

### CROSS REFERENCE TO RELATED APPLICATIONS

In accordance with 37 C.F.R. 1.76, a claim of priority is included in an Application Data Sheet filed concurrently herewith. Accordingly, the present invention claims priority as a continuation-in-part of U.S. patent application Ser. No. 14/268,600 filed May 2, 2014, entitled “Hair Bang Clipper” which is a continuation-in-part of U.S. patent application Ser. No. 12/715,143 filed Mar. 1, 2010, entitled “Hair Bang Clipper and Folding Comb” which claims the priority date of U.S. Provisional Application No. 61/156,235, entitled “Hair Bang Clipper and Folding Comb”, filed on Feb. 27, 2009, the contents of which are herein incorporated by reference.

### FIELD OF THE INVENTION

This invention is directed to the field of hair grooming and, more particularly, to a device for clipping hair.

### BACKGROUND OF THE INVENTION

Cutting hair is a very popular and necessary profession. Professional stylists have countless techniques to provide different hair styles. However, a key to a satisfied customer is for the stylists to be consistent and reproduce a certain style of hair. This requires the hair stylist to follow a similar hair clipping technique for the customer over and over again. Unfortunately, the stylist may not remember the client's style, or may charge such a premium that frequent visits are not affordable to many clients. For this reason, many people have tried to cut their own hair or rely upon friends to lessen, if not eliminate, the need for the stylist. Often the results are inconsistent and the hair style usually does not turn out how the customer had envisioned.

The trimming of hair can take many forms. Conventional hairstyling typically consists of dividing hair-bunches and cutting them at a constant angle to the scalp, and at a constant length. When the hair-bunches are aligned to a constant shape, a consistent hairstyle can be created. A hairdresser may pull each hair-bunch up at an angle of about 90 degrees to the scalp, the hair-bunch is pinched between fingers of one hand and cut using a razor or scissors with the other hand.

A shaggy hair cut is carried out by dynamically shaping hair tips. To form this hairstyle it is necessary to cut the hair at a slant while carefully placing the lengths of the hair-bunches such that all the hair-bunches are formed into the same outline. Unless the person is skilled on precisely using scissors or a razor, this style haircut can be most difficult to obtain a favorable hairstyle. For this reason, conventional razor tools are usually used by a professional hairdresser at a beauty salon.

Different hair cutting devices are frequently used to cut hair at home, by oneself, or at a salon with an experienced hair stylist. These hair cutting accessories provide different methods to create a professional quality hair cut and attempt to allow for a reproducible and somewhat professional hairstyle. However, many of the hair cutting devices and guides still require a professional eye to correctly produce a straight cut, curved cut, tapered cut, or any other different type of cut or style that requires a certain technique.

What is lacking in the art is a hair trimming tool that is simple to operate, provide repeatability and professional results, and includes a cutting blade protector to eliminate injuries that commonly occur when scissors or a razor is employed.

### PRIOR ART REFERENCES

U.S. Pat. No. 1,853,828 discloses a comb guide to facilitate the proper cutting of the hair, either by means of the mechanical hair clipper or scissors.

U.S. Pat. No. 4,428,119 discloses a pair of manually operated de-ending shears for removing split ends. The shears float like shears but cut like clippers. The device includes a moving blade slidably mounted to a still blade and handle, wherein a moving handle is provided for a cutting stroke. A spring pocketed by the blades provides the means for a reverse clipping stroke.

U.S. Pat. No. 4,660,285 discloses thinning scissors in which the cutting edge of at least one scissor blade is serrated, and the cutting edge of the other scissor blade is smooth.

U.S. Pat. No. 5,012,830 discloses a method for facilitated precision cutting of hair by one handed sectioning, combing and locking of hair into position for cutting.

U.S. Pat. No. 5,107,591 discloses thinning scissors including a serrated blade, wherein cutting teeth and non-cutting guides are spaced along the blade. The non-cutting guides will control the volume of hair to be cut in a thinning action.

U.S. Pat. No. 5,561,904 discloses a rose stem stripper having arms pivotally attached to each other at their bases.

U.S. Pat. No. 5,597,000 discloses a method and apparatus for styling hair which includes a latch mechanism for releasably securing a hair styling device about the hair strands. The latch mechanism is adapted to interconnect first and second pivotally interconnected elongated members of the hair styling device and includes a first latch member disposed substantially adjacent a first end of the first elongated member and a second latch member disposed substantially adjacent a first end of the second elongated member.

U.S. Pat. No. 6,883,239 discloses a hair-trimming device. The device comprises a substantially U-shaped member having a first handle portion and a second handle portion and an elastic portion; a pair of razor-fastener connected to the ends of the first and second handle and one lateral edge of the razor fastener being longitudinally mounted with a protective cover; and a stop mounted across the first handle and the second handle such that the handles are restricted to open.

U.S. Pat. No. 7,159,321 discloses a notched single-edge thinning scissors having chamfered edges formed in the notched blade between the hair contact side of the notched blade and the left sidewall, right sidewall and bottom wall of each notch, and between the cutting edges of the teeth of the notched blade and the left and right sidewalls of each notch for supporting the hair not to be cut during trimming.

U.S. Pat. No. 7,246,442 discloses a hair-trimming tool including a tool body having a pair of hair-bunch supporting pieces whose tip ends can open and close, a connecting portion which connects base ends of the hair-bunch supporting pieces, a protruding portion protruding from the connecting portion in a direction substantially perpendicular to an opening/closing direction of the hair-bunch supporting pieces, and a cutting element provided on at least one of the inner opposing surfaces of the hair-bunch supporting pieces along a longitudinal direction thereof.

U.S. Publication No. 2008/0060667 discloses a hair cutting device for facilitating and enhancing the ability to cut hair. The hair cutting device comprises a first elongated guide member that includes a first surface. The first surface includes a gravity field orientation sensor, to sense angular orientation.

### SUMMARY OF THE INVENTION

The instant invention is a hair clipper having a particular useful function in the clipping of bangs. The device allows an individual to clip their own bangs in a uniform or artistic manner without the need for use of conventional scissors or a razor as commonly employed. The clipper consists of a first and second arm, each having a distal and proximal end and a biasing member positioned between the arms. The distal end of each arm includes a cutting element that is positioned perpendicular to the length of the arm and in a parallel plane to the axis. When the first and second cutting elements are brought together they cooperate to clip hair in a unique chomping style operation. The use of a serrated edge on one of the cutting elements further bundles hair strands for ease of cutting.

The device includes hair alignment cover elements positioned over each arm and extending outward from the distal end of each arm. The hair alignment cover elements provide a cutting blade safety shield.

An objective of the instant invention is to provide a hair cutting tool that can be easily manufactured using pivoting arms with integrated cutting blades to provide an accurate and repeatable trimming tool that allows an individual to trim their own fringe and bangs.

Another objective of the instant invention is to provide an ergonomic design which allows single hand operation and eliminates the exposure of sharp points, such as those found on scissors.

Yet another objective of the instant invention is to provide a safety feature that prevents the cutting elements from being exposed, and limits the use of the device to trimming of hair.

Yet another objective of the instant invention is to provide serrated teeth or a textured blade on at least one cutting element to allow texture cuts typically found only with a professional hair stylist.

Yet another objective of the instant invention is to teach the use of an alignment element that is spaced apart from the cutting edge so as to prevent cutting hair too short.

Yet another objective of the instant invention is to provide a closing mechanism by use of a biasing member to provide a “chomp” or create a “one snip finish”.

Yet still another objective of the instant invention is to disclose the use of unique cutting blade designs that can be made from a variety of edges and shapes in order to create the most popular fringe styles.

Yet still another objective of the instant invention is to disclose a compact trimmer that allows for ease of storage and transport during travel.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DRAWINGS

FIG. 1 is a perspective view of the hair clipper;

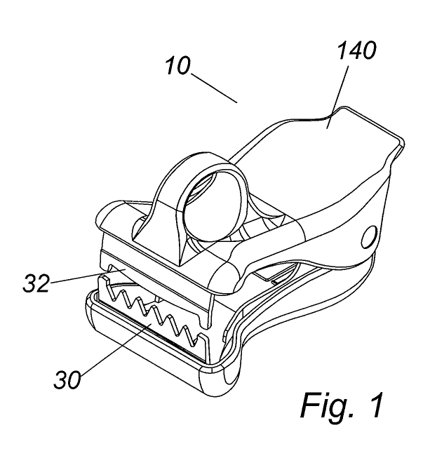

FIG. 2 is a side view of FIG. 1;

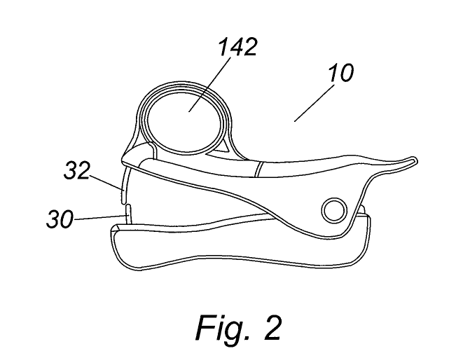

FIG. 3 is the hair clipper with a safety cover uninstalled;

FIG. 4 is the hair clipper with a safety cover installed;

FIG. 5 is an exploded view of the hair clipper;

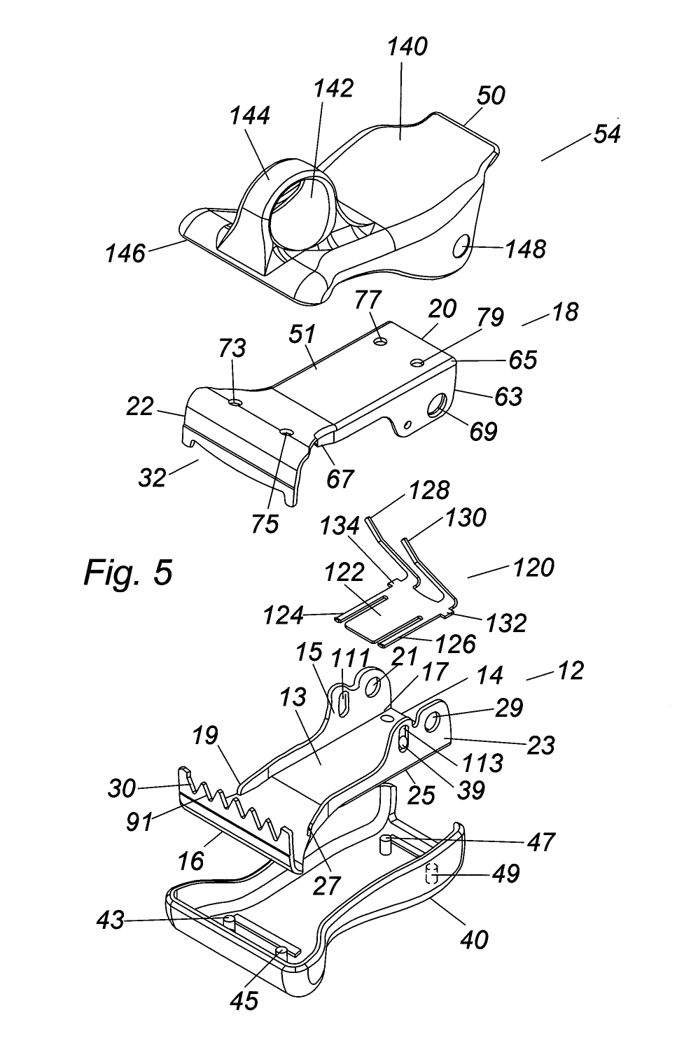

FIG. 6 is FIG. 5 with hidden lines;

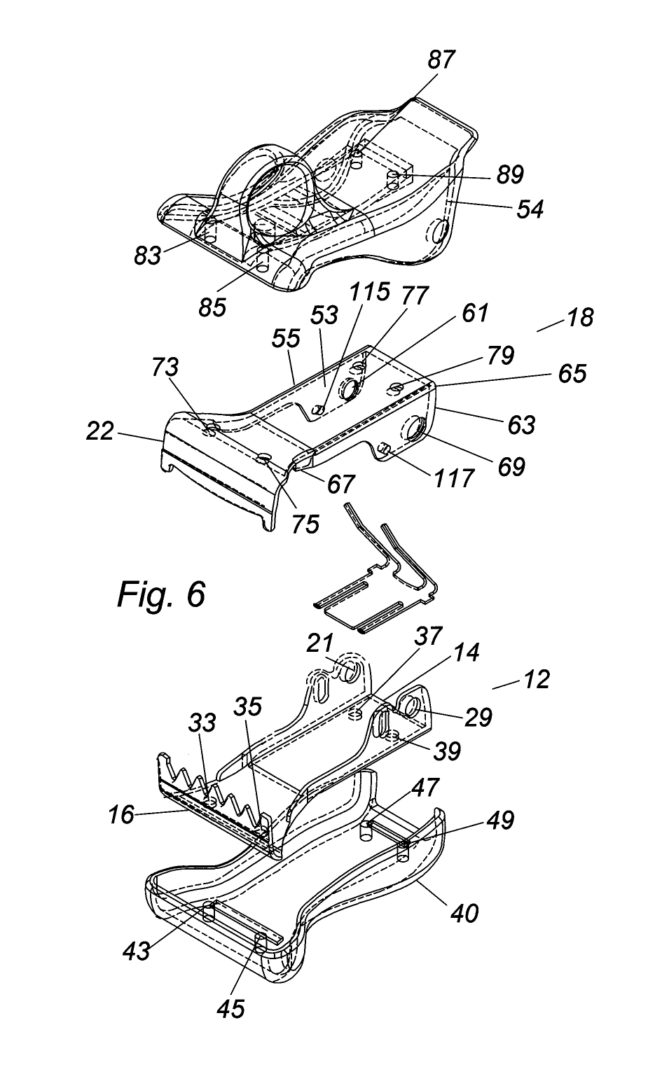

FIG. 7A is a perspective view of the upper arm;

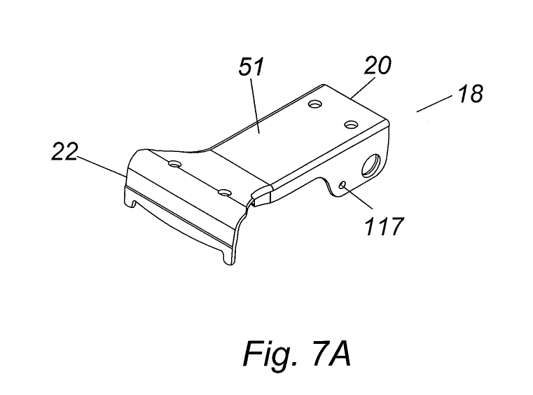

FIG. 7B is a front view of the upper arm;

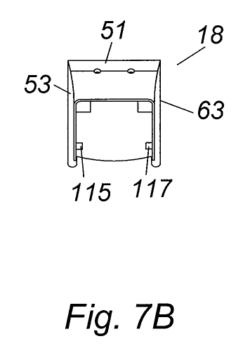

FIG. 8 is a side view of the upper and lower arms in a closed position; and

FIG. 9 is a side view of the upper and lower arms in an open position.

### DETAILED DESCRIPTION OF THE INVENTION

Now referring to the Figures in general, the hair clipper (10) has a first arm (12) having a lower wall (13) which has a proximal end (14) and a distal end (16). The lower wall (13) includes a first inner wall (15) extending upwardly from a first edge (17) of said lower wall (13), forming a length from the proximal end (14) to a point (19) adjacent the distal end (16). The first inner wall (15) having a mounting aperture (21) adjacent to the proximal end (14). A second inner wall (23) extends upwardly from a second edge (25) of said lower wall (13), forming a length from the proximal end (14) to a point (27) adjacent the distal end (16). The second inner wall (23) having a mounting aperture (29) in alignment with mounting aperture (21) of the first inner wall (15). The lower wall (13) includes corner apertures (33, 35, 37, and 39) constructed and arranged to frictionally engage corner tabs (43, 45, 47, and 49) of alignment cover (40). The cover (40) is secured to the first arm (12) by the frictional engagement of the corner tabs with the corner apertures. The cover has an ergonomic shape which substantially conceals the first arm (12), excluding an upper portion of lower cutting blade (30). It should be noted that the lower cutting blade (30) operates in conjunction with a second arm (18) having an upper cutting blade (32) to slice hair along a cutting edge. The lower cutting blade (30) and upper cutting blade (32) are pivoted so as to provide cooperating edge. The lower cutting blade (30) is formed into the shape of pointed teeth constructed and arranged to collect strands of hair with bevels along the edge of the teeth capable of cutting hair. Further, the upper cutting blade (32) has a flat edge that is shaped to provide an edge capable of cutting hair placed between the teeth. On each end of the upper cutting blade (32) are alignment tips (31, 41). The alignment tips (31, 41) are positioned to engage the inner surface of the lower cutting blade (30) and guide the upper cutting blade (32) into an exacting shearing position so that the upper cutting blade (32) is juxtapositioned to the lower cutting blade (30) in a repeatable manner, despite the amount of hair placed between the blades. In addition, when the cutting blades are not being used, a cover (150) is installed wherein the alignment tips (31, 41) engage only the upper edge of each side of cutting blade (30) so that the cutting blades (30, 32) are not stored while touching to eliminate trapped moisture from prematurely corroding the blades.

The second arm (18) has an upper wall (51) which has a proximal end (20) and a distal end (22). The upper wall (51) includes a first outer wall (53) extending downwardly from a first edge (55) of said upper wall (51) forming a length from the proximal end (20) to a point (57) adjacent the distal end (22). The first outer wall (53) includes a mounting aperture (61). A second outer wall (63) extends downwardly from a second edge (65) of said upper wall (53) forming a length from the proximal end (20) to a point (67) adjacent the distal end (22). The second outer wall (63) has a mounting aperture (69) in alignment with the mounting aperture (61) of the first outer wall (53). The upper wall (53) includes corner apertures (73, 75, 77, and 79) constructed and arranged to frictionally engage corner tabs (83, 85, 87, and 89) of alignment cover (54).

The lower cutting blade (30) is positioned along the distal end (16) of the first arm (12) and formed integral to the lower wall (13) using serrated teeth (91), wherein each tooth includes an angled edge that is sharpened like a cutting blade. The upper cutting blade (32) is positioned along the distal end (22) of the second arm (18) and formed integral to the upper wall (51). Arms (12) and (18) are each constructed from a single piece of stamped steel, eliminating the need to adjoin a separate cutting edge. The cutting blades of each arm are beveled to a precision edge and bent into position so that the blade of the first arm (12) engages the blade of the second arm (18) in a shearing arrangement.

Aperture (21) of the first arm (12) interfaces with aperture (61) of the second arm (18). Aperture (29) of the first arm (12) interfaces with aperture (69) of the second arm (18). Through a precision press process, the second arm (18) is pivotally connected to the first arm (12) wherein an edge of the apertures (61) and (69) are placed within apertures (21) and (29) respectfully. The press process forms a bearingless pivot joint that allows the distal ends (16) and (22) to pivot to an exact repeatable position so that the first and second cutting elements (30, 32) cooperate with each other to clip hair when the distal ends (16, 22) are pivoted from an open position, defined as the lower distal end (16) being separated from the upper distal end (22), to a closed position wherein the lower distal end (16) and the upper distal end (22) are engaged.

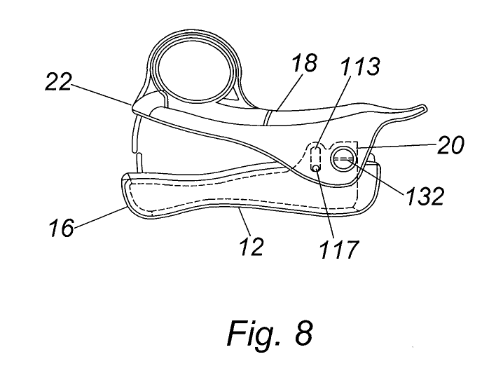

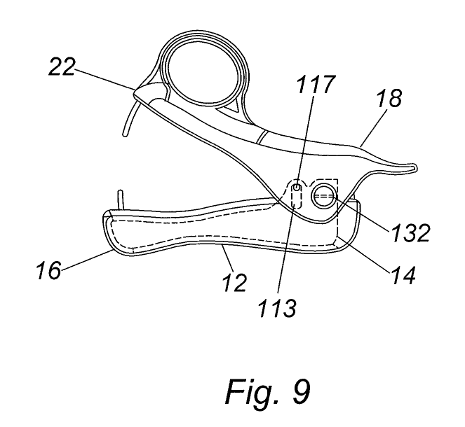

The first arm (12) further includes a first restriction slot (111) formed in sidewall (15) and a second restriction slot (113) formed in sidewall (23). The second arm (18) includes a first restriction pin (115) formed in sidewall (53) and a second restriction pin (117) formed in sidewall (63). The restriction pins are formed by a dimple press, causing a tab to extend outward from the inner side surface of each side wall (15, 23). The restriction pins (115, 117) are constructed and arranged to fit within the restriction slots (111, 113), limiting rotation of the first and second arms (12, 18). As depicted in FIG. 8, the restriction pin (117) within restriction slot (113) allows the second arm (18) to pivot into a closed position in relation to first arm (12). The restriction pin (117) is able to travel only within the length of the restriction slot (113) and, as illustrated, the restriction pin (117) is at the lower end of the restriction slot (113). As depicted in FIG. 9, the restriction pin (117) within restriction slot (113) allows the second arm (18) to pivot into an open position in relation to first arm (12). The restriction pin (117) is able to travel only within the length of the restriction slot (113) and, as illustrated, the restriction pin (117) is at the upper end of the restriction slot (113). For simplicity, restrictor pin (115) and restrictor slot (111) operate in the same manner for a balanced restriction of each arm (12, 18). Use of arms (12) and (18), each formed from a single piece of steel, provides ease of manufacturing and assembly. By incorporating the cutting elements (30, 32) as integral to each arm, assembly places the cutting elements (30, 32) in alignment without further adjustment. The use of the inner walls (15, 23) reinforces the lower wall 13 when pressed against the upper wall (51) which includes outer walls (53, 63).

A spring consisting of a biasing member (120) is incorporated between the first arm (12) and second arm (18). The biasing member (120) is constructed from spring steel, having a base (122) with parallel support arms (124, 126) to help stabilize the base by providing a balanced support against one of the arms. The biasing member (120) is bent into a predetermined position having opposing arms (128) and (130) to be biased against the pivoting arm. Securement tab (132) is positioned within apertures (29, 69), and securement tab (134) is positioned within apertures (21, 61). The securement tabs (132, 134) hold the biasing member (120) in position, wherein the spring steel maintains the second arm (18) biased in an open position, as depicted in FIG. 9. The biasing member (120) operates as a spring, and the hand squeezing of the upper member (18) against the lower member (12) as depicted in FIG. 8 temporarily overcomes the spring, wherein the distal ends (16, 22) overlap to provide a shearing cut of hair placed between the ends for purposes of trimming the hair.

A lower cover element (40) is secured to the first arm (12) employing corner tabs (43, 45, 47, and 49) molded into the lower cover (40) and sized for insertion into apertures (33, 35, 37, and 39), respectfully. The lower cover element (40) extends from a proximal end (121) to a distal end (123). The lower cover element (40) is preferably constructed from plastic, and the tabs frictionally engage the cover. Adhesive may also be used to assist or supplement the engagement to cause a permanent attachment of the cover (40) to the first arm (12). The cover (40) further provides an ornamental shape and gripping surface, concealing most of the first arm 12, excluding the cutting blade (30).

A second cover (54) is depicted for placement over second arm (18), employing corner tabs (83, 85, 87, and 89) molded into the cover (54) and sized for insertion into apertures (73, 75, 77, and 79), respectfully. The lower cover element (40) is constructed from plastic, and the tabs frictionally engage the cover. Adhesive may also be used to assist or supplement the engagement to cause a permanent attachment of the cover (54) to the second arm (18). The cover (54) further provides an ornamental shape and gripping surface, concealing most of the second arm 18, excluding the cutting blade (32). The upper surface (140) of the upper cover (54) includes a finger aperture (142), allowing an individual to properly place a human digit, preferably the index finger. The finger aperture (142) is formed from a bridge (144) that is position along the distal end (146) of the cover. The upper surface (140) has an ergonomic shape extending beyond the pivot point, as depicted by ornamental button (148), to a proximal end (50) wherein the surface (140) provides a comfortable resting position for the individual's fingers.

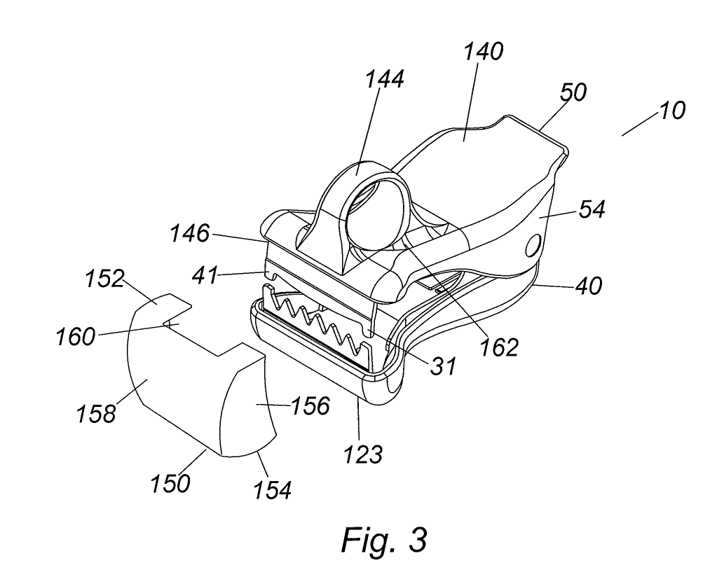

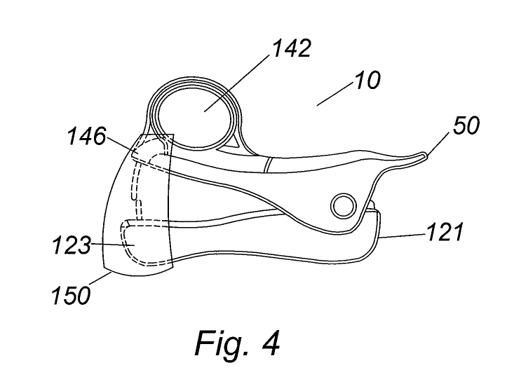

A cutting edge cover (150) is constructed and arranged to removably engage the upper and lower cover elements (40 and 54) when in a closed position. Specifically referring to FIGS. 3 and 4, the cover (150) has a top surface (152), a bottom surface, (154), a side wall (156) with an opposing side wall forming a mirror image, not shown, and a front surface (158). The upper surface (152) includes a U-shaped channel (160) that fits around the base (162) of the bridge (144) that forms the finger aperture (142). The frictional relationship between the cover (150) and the lower and upper cover elements (40 and 54) positions the cover (150) to remain in place until a user removes it. The frictional relationship is furthered because the cover (150) is sized to fit the cover elements (40 and 54) when the arms are in a closed position, whereby the biasing member (120) provides a tension on the inner surface of the cover (150), providing a safety shield by concealing the cutting blades. Preferably, the cutting edge cover (150) is transparent to allow visual inspection of the cutting blades for debris or corrosion.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention, which are obvious to those skilled in the art, are intended to be within the scope of the following claims.

What is claimed is:

1. A hair clipper comprising:
a first arm formed from a single piece of material, said first arm further defined by a length extending from a proximal end to a distal end, said distal end sharpened into a first cutting blade, a portion of said length bounded by opposing sidewalls, each said sidewall including a restriction slot and an upper aperture;
a second arm formed from a single piece of material, said second arm further defined by a length extending from a proximal end to a distal end, said distal end sharpened into a second cutting blade, a portion of said length bounded by opposing sidewalls, each said sidewall including a lower aperture pivotedly secured to said upper aperture, and a restriction pin constructed and arranged to slide within each said restriction slot permitting a predefined pivot range;
a biasing member constructed from spring steel having a first end forming a base with parallel support arms on each side of the base to contact an inner surface of first arm and a second end having spaced apart legs to contact said second arm, said biasing member including securement tabs insertable into each said upper and lower aperture;
a first cover member secured to said first arm member and a second cover member secured to said second arm member, said second arm member including an aperture formed along an upper surface sized to receive a human digit;
wherein said cutting elements cooperate to position strands of hair perpendicular to said cutting elements when said arms are placed in an open position, and for shearing of the hair when the cutting elements are pivoted into a closed position for cutting of the strands of hair.

2. The hair clipper according to claim 1 wherein said first arm includes mounting apertures for securement to first cover mounting tabs.

3. The hair clipper according to claim 1 wherein said second arm includes mounting apertures for securement to the second cover mounting tabs.

4. The hair clipper according to claim 1 wherein said second cover includes a length greater than the length from the distal end to the second cover apertures.

5. The hair clipper according to claim 1 wherein said first cutting element includes a plurality of teeth sized to capture strands of hair for ease of trimming.

6. The hair clipper according to claim 1 wherein said second cutting element includes at least one alignment tip to position said second cutting element against said first cutting element.

7. The hair clipper according to claim 1 including a storage cover arranged to frictionally engage said first and second covers to maintain said first and second arms in a closed pivot position.

8. The hair clipper according to claim 1 including connected spring mounts along an inner surface of said first arm and said second arm for biasing said distal ends in an open position.

9. The hair clipper according to claim 1 wherein said first cutting blade includes a spring mounted along an inner surface of said first arm and said second arm for biasing said distal ends in an open position.

10. The hair clipper according to claim 1 wherein said cutting elements are serrated.

11. The hair clipper according to claim 1 wherein said first cutting element includes a spacer element for positional closure of said distal ends.

12. The hair clipper according to claim 1 wherein an outer surface of each said alignment element forms an ergonomic gripping surface.

13. The hair clipper according to claim 1 includes a cutting cover constructed and arranged to frictionally engage said first and second hair alignment cutting blades on said distal end to provide safety from said first and second cutting elements.

14. The hair clipper according to claim 13 wherein said cutting edge cover is sized to space the upper blade apart from the lower blade when the cutting blade cover is installed.
